(19) United States
(12) Patent Application Publication
(10) Pub. No.: US 2026/0251331 A1
(43) Pub. Date: Aug. 27, 2026

(54) SCHEDULE MANAGEMENT SYSTEM, SCHEDULE MANAGEMENT METHOD, SCHEDULE MANAGEMENT DEVICE, AND RECORDING MEDIUM

(71) Applicant: Mitsubishi Electric Corporation, Tokyo (JP)

(72) Inventors: Noriyuki SHIMIZU, Tokyo (JP); Takahiro USHIJIMA, Tokyo (JP)

(21) Appl. No.: 18/879,440

(22) PCT Filed: Nov. 24, 2022
(86) PCT No.: PCT/JP2022/043272

§ 371 Date: Dec. 27, 2024

(51) Int. Cl. F24F 11/38; G06Q 10/0631; G06Q 10/20

(52) U.S. Cl. CPC F24F 11/38; G06Q 10/063112; G06Q 10/20

(57) ABSTRACT

A schedule management system includes an air conditioner, a communication device to acquire operation data from the air conditioner and transmit the acquired operation data, and a schedule management device including a reception unit to receive the operation data, a diagnosis unit to diagnose the air conditioner based on the operation, a selection unit to determine a work level indicating a degree of difficulty of repair or maintenance of the air conditioner based on a diagnosis result and select a worker who performs work at the work level, and a provision unit to provide support information for supporting the repair or maintenance. The selection unit selects a first worker who reaches a technical level corresponding to the work level and a second worker who is included in workers not reaching the technical level and reaches the technical level under a condition where the support information is used.

### TECHNICAL FIELD

The present disclosure relates to a schedule management system, a schedule management method, a schedule management device, and a program.

### BACKGROUND ART

In the related art, a technology of selecting a worker for failure or maintenance of equipment to be monitored is known. For example, in a failure monitoring system disclosed in Patent Document 1, a system to be maintained is monitored, and a monitoring person analyzes a failure log and selects a maintenance person necessary for maintenance. Further, the failure monitoring system provides the monitoring person with information such as a past repair history or skill of the maintenance worker to support the selection of the maintenance worker.

### CITATION LIST

### Patent Document

Patent Document 1: Japanese Unexamined Patent Application, First Publication No. 2014-199618

### SUMMARY OF INVENTION

### Technical Problem

Although the failure monitoring system provides information such as the past repair history or the skill of the maintenance worker to the monitoring person, in a case where the failure cannot be handled with the past repair history or the skill of the maintenance worker, it is not possible to select the maintenance worker even though the information such as the past repair history or the skill of the maintenance worker is provided to the monitoring person. In a case where the maintenance worker cannot be quickly selected, it may be impossible to quickly handle the failure or maintenance of the equipment to be monitored.

The present disclosure has been made in order to solve the above problems, and an objective of the present disclosure is to provide a schedule management system, a schedule management method, a schedule management device, and a program capable of quickly selecting a worker in a case where repair or maintenance of an air conditioner is required.

### Solution to Problem

A schedule management system according to a first aspect includes an air conditioner to circulate a refrigerant to perform heat exchange between the refrigerant and air, a communication device to acquire operation data from the air conditioner and transmit the acquired operation data, and a schedule management device including a reception unit to receive the operation data transmitted by the communication device, a diagnosis unit to diagnose the air conditioner based on the operation data received by the reception unit, a selection unit to determine a work level indicating a degree of difficulty of repair or maintenance of the air conditioner based on a diagnosis result of the diagnosis unit and select a worker who performs work at the work level, and a provision unit to provide support information for supporting the repair or maintenance of the air conditioner. The selection unit selects a first worker who reaches a technical level corresponding to the work level and a second worker who is included in workers not reaching the technical level corresponding to the work level and reaches the technical level corresponding to the work level under a condition where the support information is used.

A schedule management method according to a second aspect includes, via a communication device, a step of acquiring operation data from an air conditioner to circulate a refrigerant to perform heat exchange between the refrigerant and air and transmitting the acquired operation data, via a schedule management device, a step of receiving the operation data transmitted by the communication device, a step of diagnosing the air conditioner based on the operation data, a step of determining a work level indicating a degree of difficulty of repair or maintenance of the air conditioner based on a diagnosis result, and selecting a worker who performs work at the work level, and a step of providing support information for supporting the repair or maintenance of the air conditioner. In the step of selecting the worker, a first worker who reaches a technical level corresponding to the work level is selected, and a second worker who is included in workers not reaching the technical level corresponding to the work level and reaches the technical level corresponding to the work level under a condition where the support information is used is selected, A schedule management device according to a third aspect includes a reception unit to receive operation data from a communication device for acquiring the operation data from an air conditioner to circulate a refrigerant to perform heat exchange between the refrigerant and air and transmitting the acquired operation data, a diagnosis unit to diagnose the air conditioner based on the operation data received by the reception unit, a selection unit to determine a work level indicating a degree of difficulty of repair or maintenance of the air conditioner based on a diagnosis result of the diagnosis unit and select a worker who performs work at the work level, and a provision unit to provide support information for supporting the repair or maintenance of the air conditioner. The selection unit selects a first worker who reaches a technical level corresponding to the work level and a second worker who is included in workers not reaching the technical level corresponding to the work level and reaches the technical level corresponding to the work level under a condition where the support information is used.

A program according to a fourth aspect causes a computer of a schedule management device to execute a process including receiving operation data from an air conditioner to circulate a refrigerant to perform heat exchange between the refrigerant and air, diagnosing the air conditioner based on the operation data, determining a work level indicating a degree of difficulty of repair or maintenance of the air conditioner based on a diagnosis result, selecting a first worker who reaches a technical level corresponding to the work level and a second worker who is included in workers not reaching the technical level corresponding to the work level and reaches the technical level corresponding to the work level under a condition where support information for supporting the repair or maintenance of the air conditioner is used, and providing the second worker with the support information.

### Advantageous Effects of Invention

According to the present disclosure, it is possible to quickly select the worker in a case where the repair or maintenance of the air conditioner is required.

### BRIEF DESCRIPTION OF DRAWINGS

FIG. 1 A block diagram showing an example of a schedule management system according to an embodiment.

FIG. 2 A block diagram showing an example of an air conditioner according to the embodiment.

FIG. 3 A diagram showing an example of a database registered in a schedule management device according to the embodiment.

FIG. 4 A schematic diagram showing a schematic configuration of the air conditioner according to the embodiment.

FIG. 5 A block diagram showing an example of a functional configuration of an indoor unit and the schedule management device according to the embodiment.

FIG. 6 A table showing an example of work level data.

FIG. 7 A table showing an example of technical level data.

FIG. 8 A table showing an example of support information data.

FIG. 9 A diagram showing an example of support information.

FIG. 10 Tables showing an example of processing of selecting a first worker and a second worker, in which (A) of FIG. 10 is a table showing a work level and a work day of repair or maintenance of the air conditioner, (B) of FIG. 10 is a table showing an example of processing of selecting the first worker in consideration of a schedule, and (C) of FIG. 10 is a table showing an example of processing of selecting the first worker and the second worker in consideration of the schedule.

FIG. 11 Diagrams showing an example of a support information check screen provided to a terminal device for worker.

FIG. 12 A diagram showing an example of the support information for component replacement.

FIG. 13 Diagrams showing an example of a support information check screen provided to the terminal device for worker.

FIG. 14 A diagram showing an example of the support information corresponding to a model.

FIG. 15 Diagrams showing an example of a support information check screen provided for the terminal device for worker.

FIG. 16 A diagram showing an example of the support information corresponding to an inspection.

FIG. 17 A diagram showing an example of the support information corresponding to a description of an inspection result.

FIG. 18 A flowchart showing an example of a processing procedure for selecting a worker by the schedule management device according to the embodiment.

FIG. 19 A sequence diagram showing an operation procedure in the schedule management system according to the embodiment.

### DESCRIPTION OF EMBODIMENTS

Hereinafter, embodiments of the present disclosure will be described with reference to drawings. The scope of the present disclosure is not limited to the following embodiment and can be changed in any way within the scope of technical ideas of the present disclosure. Further, in the following drawings, the scale and the number in each structure may be different from the scale and the number in an actual structure to facilitate understanding of each configuration.

### Configuration of Schedule Management System

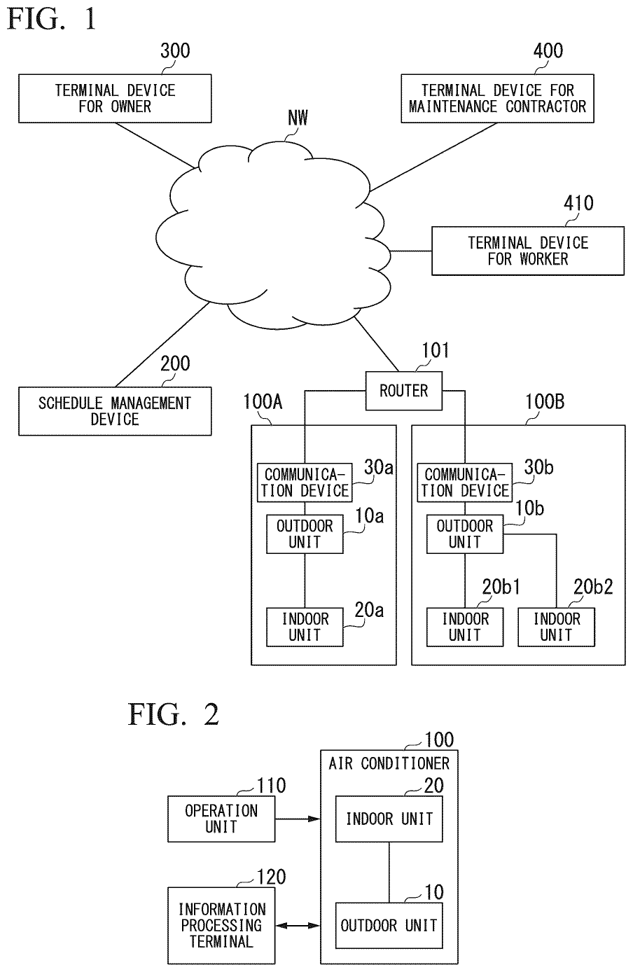

FIG. 1 is a block diagram showing an example of a schedule management system according to an embodiment. The schedule management system includes, for example, air conditioners 100A and 100B, a schedule management device 200, a terminal device for owner 300, a terminal device for maintenance contractor 400, and a terminal device for worker 410. In the following description, the air conditioner 100A and the air conditioner 100B are simply referred to as “air conditioner 100” in a case where the air conditioners are collectively referred to. The air conditioner 100A and the air conditioner 100B are connected to a network NW, such as the Internet, via a router 101. The schedule management device 200, the terminal device for owner 300, the terminal device for maintenance contractor 400, and the terminal device for worker 410 have a function of connecting to the network NW. In the following description, a user of the air conditioner 100 is referred to as “user”, an owner of the air conditioner 100 is referred to as “owner”, a person who provides a service such as maintenance of the air conditioner 100 as a business is referred to as “maintenance contractor”, and a person who performs repair or maintenance of the air conditioner 100 is referred to as “worker”.

The air conditioner 100A includes, for example, an outdoor unit 10a, an indoor unit 20a, and a communication device 30a. The air conditioner 100B includes, for example, an outdoor unit 10b, indoor units 20b1 and 20b2, and a communication device 30b. The outdoor unit 10b and the indoor units 20b1 and 20b2 are connected to each other by a signal line. In the following description, the outdoor unit is simply referred to as “outdoor unit 10”, the indoor unit is simply referred to as “indoor unit 20”, and the communication device is simply referred to as “communication device 30” in a case where the outdoor unit, the indoor unit, and the communication device are collectively referred to. The communication device 30 is connected to at least one of the indoor unit 20 and the outdoor unit 10 via a signal line. The outdoor unit 10 is disposed outdoors. The indoor unit 20 is disposed indoors. The outdoor unit 10 and the indoor unit 20 are connected to each other by a circulation path portion through which a refrigerant circulates. The air conditioner 100 circulates the refrigerant to perform heat exchange between the refrigerant and air. Accordingly, the air conditioner 100 adjusts the temperature of air in a room.

In the embodiment, for example, an example will be described in which the communication device 30 is connected to the router 101 via a wireless local area network (LAN) and the router 101 is connected to the network NW, but the present invention is not limited thereto. For example, the communication device 30 may include a communication module compatible with long term evolution (LTE) or 5G and may be connected to the network NW without going through a router. Further, an external communication device 30 may be wiredly connected to the air conditioner 100, and the communication device 30 and the router 101 may be connected by a wireless LAN.

FIG. 2 is a block diagram showing an example of the air conditioner 100 according to the embodiment. The air conditioner 100 communicates with, for example, an operation unit 110 and an information processing terminal 120. The operation unit 110 is wiredly connected to the indoor unit 20. The operation unit 110 includes an operation button or a display unit, which is operated by the user, The operation unit 110 receives the operation by the user and outputs an operation signal to the indoor unit 20. The operation unit 110 displays various types of information, such as a state of the air conditioner 100, on the display unit. The information processing terminal 120 is a smartphone or the like, which is operated by the user of the air conditioner 100.

The schedule management device 200 is an information processing device, such as a server device, that accumulates operation data of the air conditioner 100 and performs various types of processing using the operation data. The schedule management device 200 issues various notifications to the terminal device for owner 300 and the terminal device for maintenance contractor 400. The schedule management device 200 provides information related to the operation data based on requests from the terminal device for owner 300, the terminal device for maintenance contractor 400, and the terminal device for worker 410.

The schedule management system manages owner information, user information, property information related to a property in which the air conditioner 100 is installed, equipment information of the air conditioner 100, the operation data of the air conditioner 100, a schedule of the worker, and the like. For example, the schedule management system performs registration, reference, change, and deletion of the owner information, the user information, worker information, the property information, the equipment information, the operation data, and the like, based on the request received from the information processing terminal 120, the terminal device for owner 300, the terminal device for maintenance contractor 400, or the terminal device for worker 410.

The information processing terminal 120 receives, for example, the operation by the user to acquire the user information, the property information, and the equipment information. The information processing terminal 120 reads a code attached to the outdoor unit 10 or the indoor unit 20 to acquire the equipment information of the air conditioner 100. The information processing terminal 120 may acquire the equipment information of the air conditioner 100 from the operation unit 110. Further, by reading a code described on a nameplate attached to the air conditioner 100, the information processing terminal 120 can acquire the equipment information of the air conditioner 100. The user information, the property information, and the equipment information are transmitted from the information processing terminal 120 to the schedule management device 200 via the air conditioner 100. Further, for example, in a case where there is a problem or the like in the operation of the air conditioner 100, the information processing terminal 120 can also transmit a request for the repair or maintenance of the air conditioner 100 to the schedule management device 200.

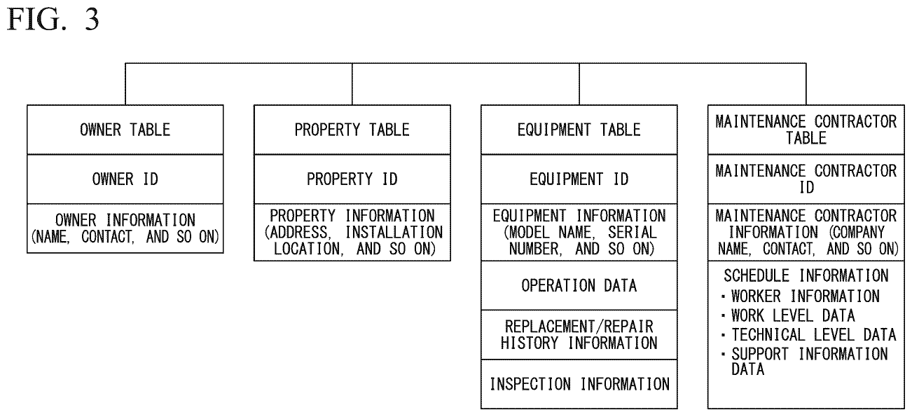

FIG. 3 is a diagram showing an example of a database registered in the schedule management device 200 according to the embodiment. The schedule management device 200 constructs, for example, an owner table, a property table, an equipment table, and a maintenance contractor table. The owner table, the property table, the equipment table, and the maintenance contractor table are associated with each other. For example, the owner, the equipment, and the maintenance contractor may be associated with the property as key information. The schedule management device 200 performs processing including registration, change, deletion, and the like of the information for the owner table, the property table, the equipment table, and the maintenance contractor table. The owner table is registered with, for example, an owner ID and owner information. The owner information includes a name, a contact, and the like of the owner. The property table is registered with a property ID and the property information. The property information includes a property name such as a building name, a property location, and the like. The equipment table is registered with an equipment ID, the equipment information, which includes a model name, a serial number, a MAC address, and the like, the operation data, replacement/repair history information, abnormality history information, and inspection information.

The replacement/repair history information includes a replacement date and a repair date of the outdoor unit 10 or the indoor unit 20, the equipment information before the replacement thereof, the equipment information after the replacement thereof, and the like. The replacement/repair history information includes a replacement date and a repair date of a component of the outdoor unit 10 or the indoor unit 20, the equipment information before the replacement thereof, the equipment information after the replacement thereof, and the like. The inspection information includes a simple inspection date of the air conditioner 100, a history of the simple inspection, an inspection record table, and the like.

The maintenance contractor table is registered with a maintenance contractor ID, maintenance contractor information, which includes a company name, a contact, and the like, and schedule information. The schedule information includes the worker information, work level data, technical level data, and support information data.

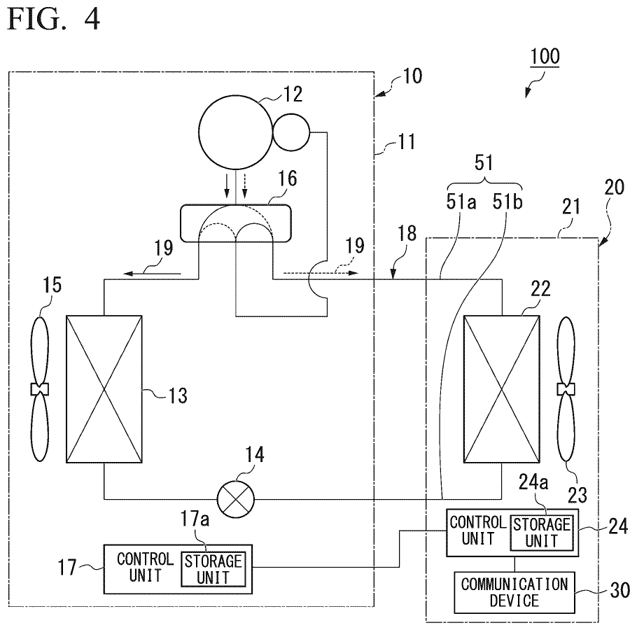

FIG. 4 is a schematic diagram showing a schematic configuration of the air conditioner 100 according to the embodiment. The air conditioner 100 includes, for example, the outdoor unit 10, the indoor unit 20, and a circulation path portion 18, With the heat exchange between a refrigerant 19 flowing inside the circulation path portion 18 and the air in the room in which the indoor unit 20 is disposed, the air conditioner 100 can adjust the temperature of the air in the room. Examples of the refrigerant 19 include a fluorine-based refrigerant having a low global warming potential (GWP) and a hydrocarbon-based refrigerant.

The outdoor unit 10 includes, for example, a housing 11, a compressor 12, a heat exchanger 13, a flow regulating valve 14, a blower 15, a four-way valve 16, and a control unit 17. The compressor 12, the heat exchanger 13, the flow regulating valve 14, the blower 15, the four-way valve 16, and the control unit 17 are accommodated inside the housing 11.

The compressor 12, the heat exchanger 13, the flow regulating valve 14, and the four-way valve 16 are provided in part of the circulation path portion 18 located inside the housing 11. The compressor 12, the heat exchanger 13, the flow regulating valve 14, and the four-way valve 16 are connected by the part of the circulation path portion 18 located inside the housing 11.

The four-way valve 16 is provided in part of the circulation path portion 18 connected to a refrigerant discharge side of the compressor 12. The four-way valve 16 switches a path of the refrigerant 19 flowing inside the circulation path portion 18 between a path indicated by a solid line and a path indicated by a broken line. The path indicated by the solid line is for returning the refrigerant 19, discharged from the compressor 12, to the compressor 12 via the heat exchanger 13, the flow regulating valve 14, and the indoor unit 20. The path indicated by the broken line is for returning the refrigerant 19, discharged from the compressor 12, to the compressor 12 via the indoor unit 20, the flow regulating valve 14, and the heat exchanger 13.

The indoor unit 20 includes a housing 21, a heat exchanger 22, a blower 23, and a control unit 24. The housing 21 accommodates the heat exchanger 22, the blower 23, the control unit 24, and the communication device 30 therein. The indoor unit 20 can perform a cooling operation to cool the air in the room in which the indoor unit 20 is disposed and a warming operation to warm the air in the room in which the indoor unit 20 is disposed.

In a case where the air conditioner 100 performs the cooling operation, the refrigerant 19 circulates through the compressor 12, the heat exchanger 13 of the outdoor unit 10, the flow regulating valve 14, and the heat exchanger 22 of the indoor unit 20 in this order and returns to the compressor 12, as indicated by a solid line arrow. In the cooling operation, the heat exchanger 13 in the outdoor unit 10 functions as a condenser, and the heat exchanger 22 in the indoor unit 20 functions as an evaporator.

In a case where the air conditioner 100 performs the warming operation, the refrigerant 19 circulates through the compressor 12, the heat exchanger 22 of the indoor unit 20, the flow regulating valve 14, and the heat exchanger 13 of the outdoor unit 10 in this order and returns to the compressor 12, as indicated by a broken line arrow. In the warming operation, the heat exchanger 13 in the outdoor unit 10 functions as the evaporator, and the heat exchanger 22 in the indoor unit 20 functions as the condenser.

The control unit 24 is mounted on a circuit board in the indoor unit 20, together with the communication device 30 and a storage unit 24a. The control unit 24 controls each part of the indoor unit 20. The control unit 17 is mounted on a circuit board in the outdoor unit 10, together with a storage unit 17a. The control unit 17 controls each part of the outdoor unit 10. For example, a processor such as a central processing unit (CPU) executes a program stored in a program memory to realize the control unit 24 and the control unit 17. Software, firmware, or a combination of software and firmware is described as a program, and the program is stored in the program memory. Further, some or all of the functional units may be realized by hardware such as large scale integration (LSI), application specific integrated circuit (ASIC), or field-programmable gate array (FPGA), or may be realized by cooperation between software and hardware.

The storage units 17a and 24a are formed by, for example, a non-volatile or volatile semiconductor memory such as a random access memory (RAM), a read-only memory (ROM), a flash memory, an erasable programmable read-only memory (EPROM), or an electrically erasable and programmable ROM (EEPROM). The communication device 30 acquires the operation data from the air conditioner 100 and transmits the acquired operation data. The operation data transmitted to the air conditioner 100 by the communication device 30 includes the operation data stored in the storage units 24a and the storage unit 17a.

Specifically, the control unit 24 communicates with the operation unit 110 and the information processing terminal 120 via the communication device 30. The control unit 24 receives signals from sensors (not shown) mounted on the outdoor unit 10 and the indoor unit 20. The control unit 24 controls a motor in the blower 23. The control unit 24 supplies a control signal for operating the outdoor unit 10 to the control unit 17. The control unit 17 controls a motor in the compressor 12, a motor in the blower 15, an actuator in the four-way valve 16, and an actuator in the flow regulating valve 14.

The sensor may include, for example, temperature sensors that detect various temperatures such as an outside air temperature, a room temperature, a refrigerant pipe temperature, and a shell temperature of the compressor 12, sensors that detect various driving amounts such as a driving amount of the blower 15, a driving amount of the blower 23, and a driving amount of the compressor 12, sensors that detect various operations such as an operation of the flow regulating valve 14 and an operation of the four-way valve 16, and refrigerant leakage sensors disposed around the outdoor unit 10 and the indoor unit 20.

Hereinafter, the operation data will be described.

The operation data relates to the operation of the air conditioner 100. The operation data includes data related to the overall operation of the air conditioner 100, data related to the operation of the outdoor unit 10, data related to the operation of the indoor unit 20, data related to the operation of the component of the outdoor unit 10, and data related to the component of the indoor unit 20. The operation data can be used for diagnosis of the air conditioner 100.

The operation data includes data for diagnosing the outdoor unit 10 and the indoor unit 20. The operation data may be, for example, data indicating whether or not a float switch installed in a drain pan has detected a first water level. Accordingly, the schedule management device 200 can diagnose the abnormality of a drain water discharge operation. The operation data may be data indicating whether or not a pipe temperature is equal to or lower than a protection temperature by a thermistor attached to an indoor refrigerant pipe. Accordingly, the schedule management device 200 can diagnose, during the cooling operation, an abnormality in which the indoor refrigerant pipe is frozen due to an operation load condition or the like. The operation data may be data indicating whether or not the pipe temperature is equal to or larger than the protection temperature by the thermistor attached to the indoor refrigerant pipe. Accordingly, the schedule management device 200 can diagnose, during the warming operation, an abnormality in which the indoor pipe temperature excessively rises due to the operation load condition or the like. The operation data may be data indicating whether or not a refrigerant pressure exceeds a design pressure. Accordingly, the schedule management device 200 can diagnose the abnormality in which the refrigerant pressure exceeds the design pressure due to clogging or bending of the refrigerant pipe, a short cycle, failure of indoor and outdoor fan motors, or the like. The operation data may be data indicating whether or not an abnormal temperature is detected by a thermistor that detects a refrigerant temperature discharged from the compressor 12. Accordingly, the schedule management device 200 can diagnose an abnormality in which the temperature of the refrigerant 19 discharged from the compressor 12 exceeds a design temperature due to a heating operation of the compressor 12 caused by refrigerant shortage, valve malfunction of the four-way valve 16 or the flow regulating valve 14, or the like. The operation data may be data indicating whether or not a shell thermistor attached to the compressor 12 has detected the abnormal temperature. Accordingly, the schedule management device 200 can diagnose an abnormality in which the temperature of a shell constituting an outer contour of the compressor 12 exceeds the design temperature, which is decided according to an allowable temperature of each component such as the compressor 12, due to the heating operation of the compressor 12 caused by the refrigerant shortage, the valve operation failure of the four-way valve 16 or the flow regulating valve 14, or the like. The operation data may be data indicating whether or not a period in which discharge superheat exceeds a predetermined value continues for a set time. Accordingly, the schedule management device 200 can diagnose an abnormality in which the refrigerant 19 leaks and the refrigerant 19 is insufficient due to the heating operation of the compressor 12 caused by the refrigerant shortage, the valve operation failure of the four-way valve 16 or the flow regulating valve 14, or the like. The operation data may be data for determining whether or not the refrigerant pressure falls below the design pressure. Accordingly, the schedule management device 200 can diagnose an abnormality in which the refrigerant pressure falls below the design pressure due to malfunction of an electronic expansion valve or the like, foreign matter in the refrigerant pipe, or the like.

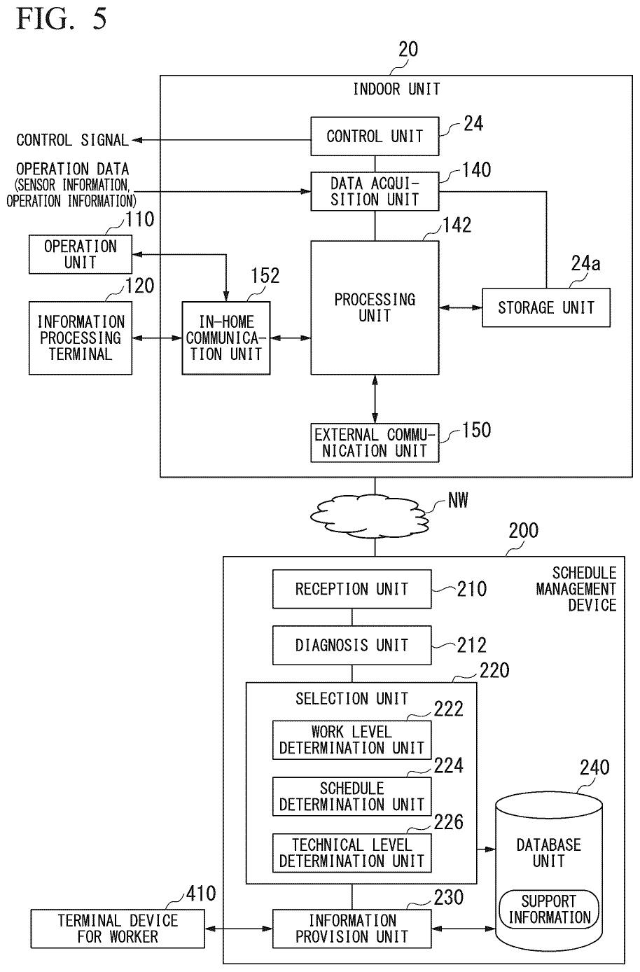

FIG. 5 is a block diagram showing an example of a functional configuration of the indoor unit 20 and the schedule management device 200 according to the embodiment. The indoor unit 20 includes, for example, the control unit 24, a data acquisition unit 140, a processing unit 142, the storage unit 24a, an external communication unit 150, and an in-home communication unit 152. The external communication unit 150 is a functional unit corresponding to the communication device 30. For example, a processor such as a CPU executes a program stored in the program memory to realize the data acquisition unit 140 and the processing unit 142. The control unit 24, the data acquisition unit 140, the processing unit 142, the storage unit 24a, the external communication unit 150, and the in-home communication unit 152 each may be mounted on any one of the outdoor unit 10 and the indoor unit 20, or may be mounted in a distributed manner on the outdoor unit 10 and the indoor unit 20.

The control unit 24 outputs the control signal to each part of the air conditioner 100. The data acquisition unit 140 acquires the operation data from each part of the air conditioner 100. The storage unit 24a stores the operation data. The processing unit 142 transmits the operation data stored in the storage unit 144 to the schedule management device 200 via the external communication unit 150 and the router 101. The in-home communication unit 152 performs wired communication with the operation unit 110. The in-home communication unit 152 communicates with the information processing terminal 120 using a short-range communication method. The short-range communication method is, for example, Wi-Fi (registered trademark) or Bluetooth (registered trademark).

The schedule management device 200 includes, for example, a reception unit 210, a diagnosis unit 212, a selection unit 220, an information provision unit 230, and a database unit 240. The reception unit 210 receives the operation data transmitted from the external communication unit 150 (communication device 30). The diagnosis unit 212 diagnoses the air conditioner 100 based on the operation data received by the reception unit 210.

The selection unit 220 determines a work level indicating a degree of difficulty of the repair or maintenance of the air conditioner 100 based on a diagnosis result of the diagnosis unit 212, and selects a worker who performs work at the work level. The selection unit 220 includes, for example, a work level determination unit 222, a schedule determination unit 224, and a technical level determination unit 226. For example, a processor such as a CPU executes a program stored in the program memory to realize the work level determination unit 222, the schedule determination unit 224, and the technical level determination unit 226. In the embodiment, the work level represents the degree of difficulty of the repair or maintenance of the air conditioner 100, and a technical level represents a skill level of the worker.

The work level determination unit 222 determines the work level indicating the degree of difficulty of the repair or maintenance of the air conditioner 100 based on the diagnosis result of the diagnosis unit 212. The schedule determination unit 224 receives a work day for performing the repair or maintenance of the air conditioner 100 and determines whether or not a first worker can be assigned on the received work day. The first worker is a worker who has reached the technical level corresponding to the work level determined by the work level determination unit 222. The technical level determination unit 226 selects the first worker and a second worker who is included in workers not reaching the technical level corresponding to the work level and reaches the technical level corresponding to the work level under a condition where support information is used. In a case where the schedule determination unit 224 determines that the first worker cannot be assigned to the work day, the schedule determination unit 224 may select the second worker.

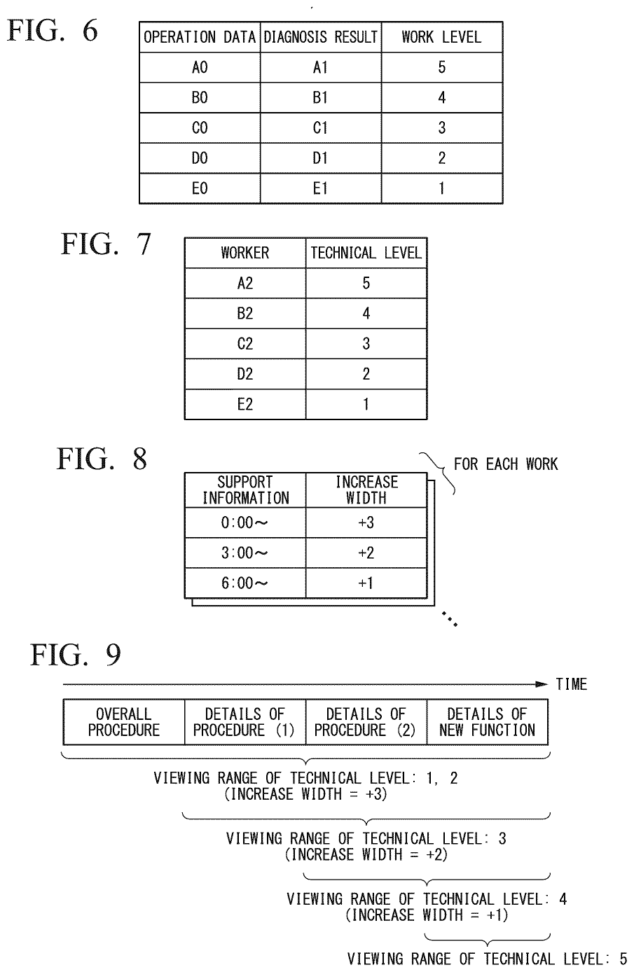

FIG. 6 is a table showing an example of the work level data. FIG. 7 is a table showing an example of the technical level data. FIG. 8 is a table showing an example of the support information data. FIG. 9 is a diagram showing an example of the support information. The database unit 240 stores the work level data, the technical level data, the support information data, the support information, and information such as the work day.

The work level data is data in which the operation data, the information indicating the repair or maintenance of the air conditioner 100, and the work level are associated with each other. The work level data may be data in which the diagnosis result based on the operation data, the information indicating the repair or maintenance of the air conditioner 100, and the work level are associated with each other. The technical level data is data in which the information indicating the worker and the technical level are associated with each other. The technical level is decided by, for example, years of experience, skill of a worker, a component that has been replaced, the number of times of the replacement of the component, whether or not there is experience in welding (advanced work), or whether or not there is a license. The technical level is updated, for example, based on a request from the terminal device for maintenance contractor 400. The support information data is data in which the support information and an increase width of the technical level are associated with each other. The support information is, for example, a content created for each repair or maintenance work of the air conditioner 100 but is not limited thereto and may be a content for each model of the air conditioner 100. For example, as shown in FIG. 9, the support information is video data of a manual and includes a video image describing an overall procedure of work, a video image describing details of a procedure (1) of the work, a video image describing details of a procedure (2) of the work, and a video image describing details of a new function of the air conditioner 100 related to the work.

The work level determination unit 222 of the selection unit 220 acquires, based on the work level data, the work level corresponding to the operation data transmitted by the communication device 30. The work level determination unit 222 may acquire, based on the work level data, the work level corresponding to the diagnosis result based on the operation data. The technical level determination unit 226 of the selection unit 220 acquires, based on the technical level data, information indicating the first worker who satisfies the technical level corresponding to the work level acquired by the work level determination unit 222. The technical level determination unit 226 further acquires information indicating the second worker based on the technical level data and the support information data. The technical level determination unit 226 acquires, for example, information indicating a worker whose technical level is “4” on a condition that the work level corresponding to the diagnosis result is “5” and the support information corresponding to the increase width of “+1” is used.

With provision of the support information to the worker having a low technical level, the information provision unit 230 can increase the technical level of the worker.

The information provision unit 230 decreases a range of the support information provided to the terminal device for worker 410, which corresponds to the second worker, as the technical level of the second worker is higher. For example, as shown in FIG. 9, with provision of all the video images of the support information to the workers having the technical levels of “1” and “2”, the information provision unit 230 can increase the technical level of the second worker by “+3”. With provision of the video images of the procedure (1), the procedure (2), and the new function in the support information to the worker having the technical level of “3”, the information provision unit 230 can increase the technical level of the second worker by “2”. With provision of the video images of the procedure (2) and the new function in the support information to the worker having the technical level of “4”, the information provision unit 230 can increase the technical level of the second worker by “1”. The information provision unit 230 may provide the video images of the new function of the air conditioner 100 and the like as the support information to all workers.

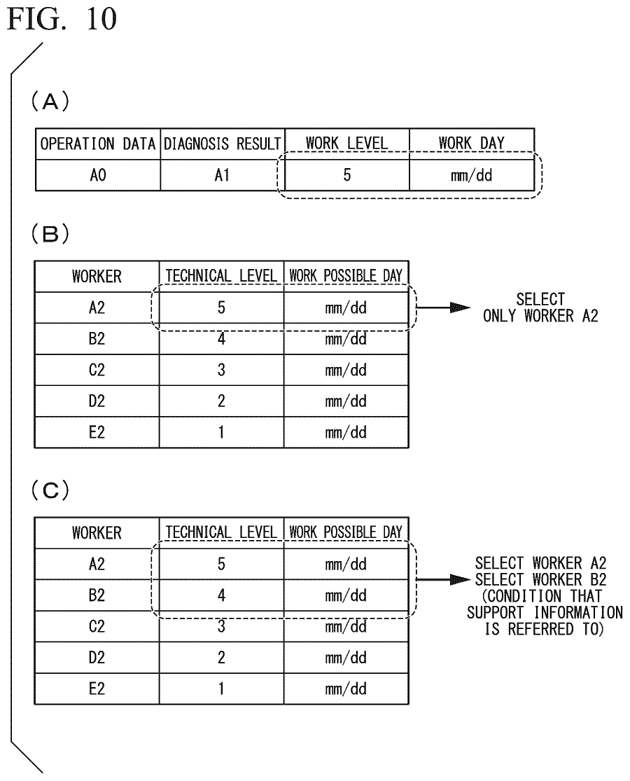

FIG. 10 is tables showing an example of processing of selecting the first worker and the second worker. (A) of FIG. 10 is a table showing the work level and the work day of the repair or maintenance of the air conditioner 100. (B) of FIG. 10 is a table showing an example of the processing of selecting the first worker in consideration of a schedule (work possible day), (C) of FIG. 10 is a table showing an example of the processing of selecting the first worker and the second worker in consideration of the schedule (work possible day). For example, as shown in (A) of FIG. 10, for the repair or maintenance at the work level of “5”, the work day of the repair or maintenance is set based on the request from, for example, the terminal device for owner 300 or the information processing terminal 120. The schedule determination unit 224 refers to the schedule of the worker to select workers A1 to E2 who can perform work on the set work day. The technical level determination unit 226 selects the worker A2 having the work level of “5” among the workers A1 to E2 as the first worker, as shown in (B) of FIG. 10. Further, the technical level determination unit 226 can select the worker B2 having the technical level of “4” with reference to the support information data, on a condition that the support information is used, as shown in (C) of FIG. 10.

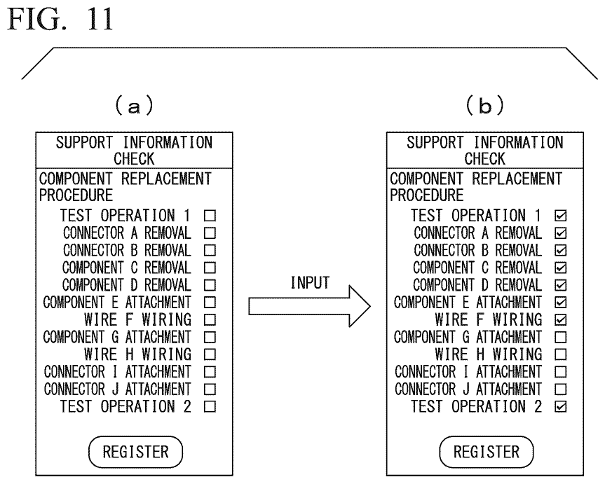

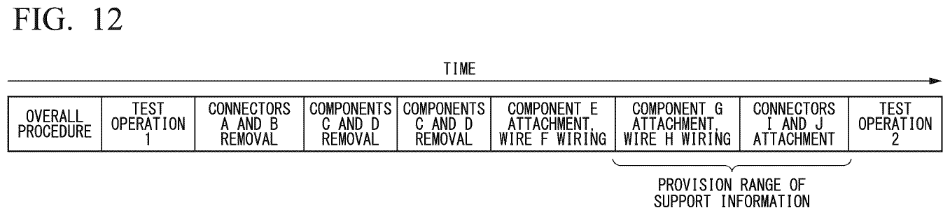

FIG. 11 is diagrams showing an example of a support information check screen provided to the terminal device for worker 410. FIG. 12 is a diagram showing an example of the support information for the component replacement. The information provision unit 230 provides the terminal device for worker 410 held by the worker with a content for checking whether or not to provide the support information, and the terminal device for worker 410 displays the support information check screen as shown in (a) of FIG. 11. The support information check screen shows that the repair or maintenance of the air conditioner 100 performed by the worker is for replacing a component, and includes work items in the component replacement and check boxes corresponding to the work items. The terminal device for worker 410 receives an input operation of the worker and provides the schedule management device 200 with information indicating the work items with the check boxes not operated. The information provision unit 230 of the schedule management device 200 provides the terminal device for worker 410 with the support information in a range corresponding to the information indicating the work items with the check boxes not operated, among the support information for the component replacement as shown in (b) of FIG. 11 and FIG. 12. The information provision unit 230 may not be able to select the check box for the work item for which viewing of the support information is requested according to the technical level of the worker among the plurality of work items.

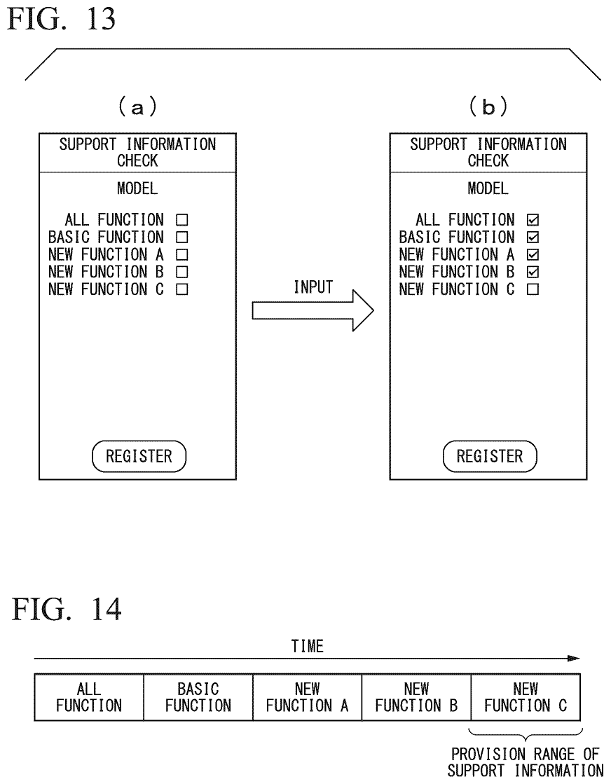

FIG. 13 is diagrams showing an example of the support information check screen provided for the terminal device for worker 410. FIG. 14 is a diagram showing an example of the support information corresponding to a model. The information provision unit 230 provides the terminal device for worker 410 held by the worker with a content for checking whether or not to provide the support information of the latest model, and the terminal device for worker 410 displays the support information check screen of the latest model as shown in (a) of FIG. 13. The support information check screen includes items describing a repair method or a maintenance method corresponding to functions of the latest model and includes check boxes corresponding to the items.

The terminal device for worker 410 receives an input operation of the worker and provides the schedule management device 200 with information indicating the items with the check boxes not operated. As shown in (b) of FIG. 13 and FIG. 14, the information provision unit 230 of the schedule management device 200 provides the terminal device for worker 410 with the support information in a range corresponding to the information indicating the items with the check boxes not operated, among the support information for the latest model. The information provision unit 230 may not be able to select the check box for the item for which viewing of the support information is requested according to the technical level of the worker among the plurality of items.

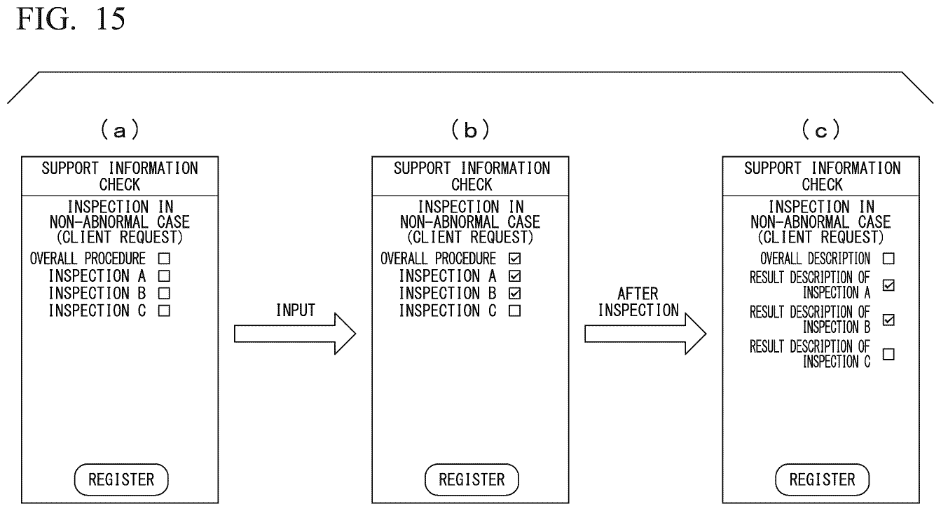

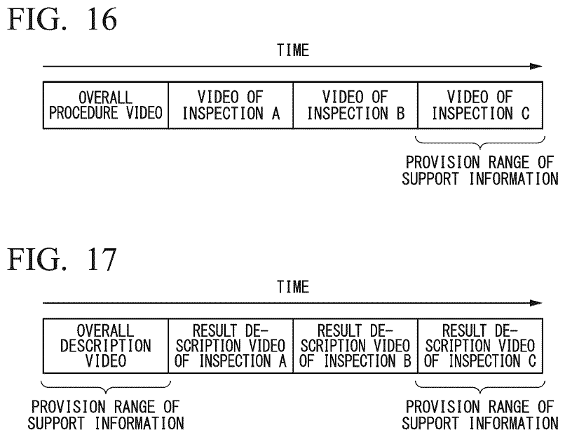

FIG. 15 is diagrams showing an example of the support information check screen provided to the terminal device for worker 410. FIG. 16 is a diagram showing an example of the support information corresponding to the inspection. FIG. 17 is a diagram showing an example of the support information corresponding to a description of an inspection result. The information provision unit 230 provides the terminal device for worker 410 held by the worker with a content for checking whether or not to provide the support information for performing the inspection in a non-abnormal case, and the terminal device for worker 410 displays the support information check screen for an inspection procedure as shown in (a) of FIG. 15. The inspection in the non-abnormal case is performed, for example, in response to the request from the information processing terminal 120 or the terminal device for owner 300, although an abnormality is not detected even in a case where the diagnosis unit 212 performs the diagnosis based on the operation data. The support information check screen includes an overall procedure for inspecting the abnormality of the air conditioner 100, an item corresponding to each of inspection items, and a check box corresponding to the item. The terminal device for worker 410 receives an input operation of the worker and provides the schedule management device 200 with information indicating the item with the check boxes not operated. As shown in (b) of FIG. 15 and FIG. 16, the information provision unit 230 of the schedule management device 200 provides the terminal device for worker 410 with the support information in a range corresponding to the information indicating the item with the check boxes not operated, among the support information for the latest model.

Accordingly, the information provision unit 230 can provide the overall procedure and the inspection item of the inspection in the non-abnormal case to the worker and thus provide the support information for the inspection item that the worker has not noticed. The information provision unit 230 may not be able to select the check box for the item for which viewing of the support information is requested according to the technical level of the worker among the plurality of items.

After the inspection is completed from the terminal device for worker 410, the information provision unit 230 provides the terminal device for worker 410 with a content for displaying a screen including an overall description of the inspection, an item corresponding to each result description of the inspection items, and a check box corresponding to the item, as shown in (c) of FIG. 15. The terminal device for worker 410 receives an input operation of the worker and provides the schedule management device 200 with the information indicating the item with the check boxes not operated.

As shown in FIG. 17, the information provision unit 230 of the schedule management device 200 provides the terminal device for worker 410 with the support information in a range corresponding to the information indicating the item with the check boxes not operated, among the support information. Accordingly, the information provision unit 230 can provide the worker with a video for describing the inspection result. The information provision unit 230 may not be able to select the check box for the item for which viewing of the support information is requested according to the technical level of the worker among the plurality of items.

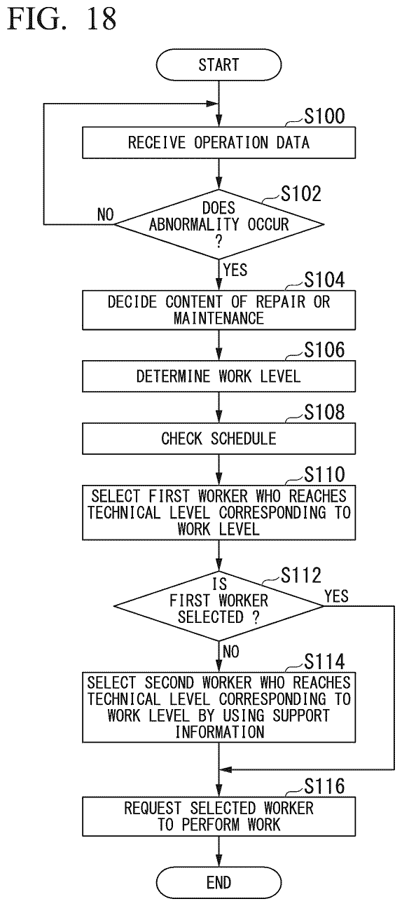

FIG. 18 is a flowchart showing an example of a processing procedure for selecting the worker by the schedule management device 200 according to the embodiment. First, the reception unit 210 receives the operation data from the air conditioner 100 (step S100), and the diagnosis unit 212 diagnoses the air conditioner 100 based on the operation data. The diagnosis unit 212 determines whether or not an abnormality has occurred in the air conditioner 100 (step S102). In a case where no abnormality occurs in the air conditioner 100 (step S102: NO), the diagnosis unit 212 repeats the reception and the diagnosis of the operation data (step S101 and step S102). In a case where the abnormality occurs in the air conditioner 100 (step S102: YES), the diagnosis unit 212 decides a work content of the repair or maintenance for the diagnosis result (step S104), and the work level determination unit 222 determines the work level of the work content of the repair or maintenance corresponding to the diagnosis result (step S106).

Next, the schedule determination unit 224 checks the schedule of the worker who has an open schedule on the work day on which the repair or maintenance is performed on the air conditioner 100 (step S108). The technical level determination unit 226 selects the first worker who has reached the technical level corresponding to the work level, among the workers who have an open schedule on the work day on which the repair or maintenance is performed on the air conditioner 100 (step S110).

The technical level determination unit 226 determines whether or not the first worker is selected (step S112). In a case where the technical level determination unit 226 selects the first worker (step S112: YES), the schedule management device 200 provides the terminal device for worker 410, which corresponds to the selected first worker, with information for requesting work (step S116).

In a case where the technical level determination unit 226 does not select the first worker (step S112: NO), the technical level determination unit 226 selects the second worker who reaches the technical level corresponding to the work level under a condition where the support information is used (step S114). The schedule management device 200 provides the terminal device for worker 410, which corresponds to the selected second worker, with the information for requesting work (step S116).

As described above, the schedule management system according to the embodiment includes the air conditioner 100 that circulates the refrigerant to perform the heat exchange between the refrigerant and the air, the communication device 30 that acquires the operation data from the air conditioner 100 and transmits the acquired operation data, and the schedule management device 200 including the reception unit 210 that receives the operation data transmitted by the communication device 30, the diagnosis unit 212 that diagnoses the air conditioner 100 based on the operation data received by the reception unit 210, the selection unit 220 that determines the work level indicating the degree of difficulty of the repair or maintenance of the air conditioner 100 based on the diagnosis result of the diagnosis unit 212 and selects the worker who performs the work at the work level, and the information provision unit 230 that provides the support information for supporting the repair or maintenance of the air conditioner 100. The selection unit 220 selects the first worker who reaches the technical level corresponding to the work level and the second worker who is included in workers not reaching the technical level corresponding to the work level and reaches the technical level corresponding to the work level under a condition where the support information is used, With the schedule management system, it is possible to quickly select the worker in a case where the repair or maintenance of the air conditioner 100 is required.

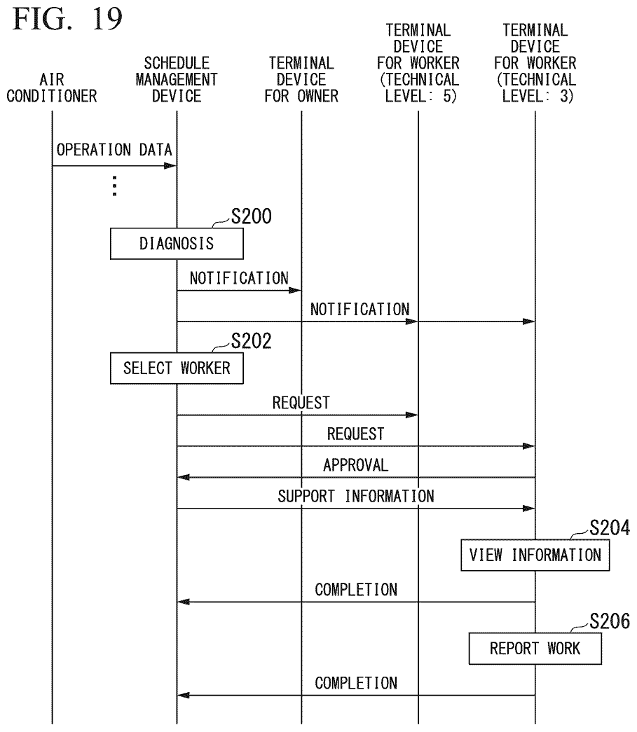

FIG. 19 is a sequence diagram showing an operation procedure in the schedule management system according to the embodiment. As described with reference to FIG. 18, the selection unit 220 selects the second worker in a case where the schedule determination unit 224 determines that the first worker cannot be assigned on the work day, but the present invention is not limited thereto. The schedule management device 200 may provide both the terminal device for worker 410 corresponding to the first worker and the terminal device for worker 410 corresponding to the second worker with information for requesting the repair or maintenance of the air conditioner 100.

First, the air conditioner 100 provides the schedule management device 200 with the operation data, and the reception unit 210 of the schedule management device 200 receives the provided operation data. The diagnosis unit 212 diagnoses the air conditioner 100 using the received operation data (step S200). In a case where the air conditioner 100 has an abnormality as a result of the diagnosis, the schedule management device 200 issues the notifications to the terminal device for owner 300, the terminal device for maintenance contractor 400 (not shown), and the terminal device for worker 410.

Next, the selection unit 220 selects the first worker and the second worker (step S202). The work level determination unit 222 determines the work level corresponding to the diagnosis result. The schedule determination unit 224 determines the worker who is able to perform the work on the work day on which the repair or maintenance of the air conditioner 100 having an abnormality is performed. The technical level determination unit 226 selects the first worker who has the technical level corresponding to the work level and the second worker who is included in the workers available on the work day and reaches the technical level corresponding to the work level under a condition where the support information is used. The schedule management device 200 simultaneously requests both the terminal device for worker 410 corresponding to the first worker and the terminal device for worker 410 corresponding to the second worker, which are selected by the technical level determination unit 226, to perform the repair or maintenance of the air conditioner 100.

For example, it is assumed that, in the schedule management device 200, the technical level required for the repair or maintenance of the air conditioner 100 is “5”, and the first worker having the technical level of “5” and the second worker having the technical level of “3” are requested. It is assumed that the schedule management device 200 does not receive a response of approval from the terminal device for worker 410 corresponding to the first worker having the technical level of “5”, but receives the response of approval from the terminal device for worker 410 corresponding to the second worker having the technical level of “3”. In this case, the information provision unit 230 transmits the support information for increasing the technical level of the second worker from “3” to “5” to the terminal device for worker 410 corresponding to the second worker, The terminal device for worker 410 corresponding to the second worker receives the support information and causes the second worker to view the video image as the support information (step S204), The terminal device for worker 410 transmits, to the schedule management device 200, a completion notification indicating that the browsing of the support information is completed.

In a case where the repair or maintenance of the air conditioner 100 is performed, the second worker reports the completion of the work (step S206), and the terminal device for worker 410 transmits, to the schedule management device 200, the completion notification indicating that the work of the repair or maintenance of the air conditioner 100 is completed.

As described above, with the provision of the information for requesting the repair or maintenance of the air conditioner 100 to both the first worker and the second worker, the schedule management device 200 can quickly schedule the repair or maintenance of the air conditioner 100.

Although the embodiments of the present disclosure have been described in detail with reference to the drawings, the specific configurations are not limited to the above embodiments, and also include design and the like within the scope of the gist of the present disclosure. The configurations described in the above embodiments can be combined in any manner. For example, in the embodiments, the air conditioner 100 is described as a target of work, but the present invention is not limited thereto, and the above embodiments may be applied to any work, such as equipment replacement, component replacement, repair, or cleaning, that requires association or takeover of the operation data before and after the work.

### REFERENCE SIGNS LIST

10, 10a, 10b outdoor unit
12 compressor
13 heat exchanger
14 flow regulating valve
15 blower
16 four-way valve
17 control unit
17a, 24a storage unit
19 refrigerant
21 housing
22 heat exchanger
23 blower
24 control unit
20, 20a, 20b1, 20b2 indoor unit
30, 30a, 30b communication device
100, 100A, 100B air conditioner
101 router
110 operation unit
120 information processing terminal
140 data acquisition unit
142 processing unit
144 storage unit
150 external communication unit
152 in-home communication unit
200 schedule management device
210 reception unit
212 diagnosis unit
220 selection unit
222 work level determination unit
224 schedule determination unit
226 technical level determination unit
230 information provision unit
240 database unit

1. A schedule management system comprising:
an air conditioner to circulate a refrigerant to perform heat exchange between the refrigerant and air;
a communication device to acquire operation data from the air conditioner and transmit the acquired operation data; and
a schedule management device including reception circuitry to receive the operation data transmitted by the communication device, diagnosis circuitry to diagnose the air conditioner based on the operation data received by the reception circuitry, selection circuitry to determine a work level indicating a degree of difficulty of repair or maintenance of the air conditioner based on a diagnosis result of the diagnosis circuitry and select a worker who performs work at the work level, and provision circuitry to provide support information for supporting the repair or maintenance of the air conditioner,
wherein the selection circuitry selects a first worker who reaches a technical level corresponding to the work level and a second worker who is included in workers not reaching the technical level corresponding to the work level and reaches the technical level corresponding to the work level under a condition where the support information is used.

2. The schedule management system according to claim 1,
wherein the selection circuitry includes a schedule determination circuitry to receive a work day on which the repair or maintenance of the air conditioner is to be performed and determines whether or not the first worker is possible to be assigned on the received work day, and selects the second worker in a case where the schedule determination circuitry determines that the first worker is not possible to be assigned on the work day.

3. The schedule management system according to claim 1,
wherein the schedule management device provides both a terminal device corresponding to the first worker and a terminal device corresponding to the second worker with information for requesting the repair or maintenance of the air conditioner.

4. The schedule management system according to claim 1,
wherein the schedule management device includes database circuitry to register work level data in which the operation data, information indicating the repair or maintenance of the air conditioner, and the work level are associated with each other, technical level data in which information indicating the worker and the technical level are associated with each other, and support information data in which the support information and an increase width of the technical level are associated with each other, and
the selection circuitry acquires the work level corresponding to the operation data transmitted by the communication device based on the work level data, acquires information indicating the first worker satisfying the technical level corresponding to the acquired work level based on the technical level data, and acquires information indicating the second worker based on the technical level data and the support information data.

5. The schedule management system according to claim 1,
wherein the provision circuitry decreases a range of the support information provided to a terminal device, which corresponds to the second worker, as the technical level of the second worker is higher.

6. The schedule management system according to claim 1,
wherein the provision circuitry provides a terminal device, which corresponds to the second worker, with a content for selecting a work item for which the support information is provided among work items included in the repair or maintenance of the air conditioner based on the operation data and provides the support information corresponding to the work item selected by the second worker.

7. The schedule management system according to claim 1,
wherein the provision circuitry provides a terminal device, which corresponds to the second worker, with a content for selecting a function for which the support information is provided among functions of the air conditioner to be repaired or maintained based on the operation data and provides the support information corresponding to the function selected by the second worker.

8. The schedule management system according to claim 1,
wherein the provision circuitry provides a terminal device, which corresponds to the second worker, with a content for selecting an inspection item for which the support information is provided among inspection items of the air conditioner to be repaired or maintained based on the operation data and provides the support information corresponding to the inspection item selected by the second worker.

9. A schedule management method comprising:
via a communication device,
acquiring operation data from an air conditioner to circulate a refrigerant to perform heat exchange between the refrigerant and air and transmitting the acquired operation data;
via a schedule management device,
receiving the operation data transmitted by the communication device;
diagnosing the air conditioner based on the operation data;
determining a work level indicating a degree of difficulty of repair or maintenance of the air conditioner based on a diagnosis result, and selecting a worker who performs work at the work level; and
providing support information for supporting the repair or maintenance of the air conditioner,
wherein the selecting the worker includes selecting a first worker who reaches a technical level corresponding to the work level and a second worker who is included in workers not reaching the technical level corresponding to the work level and reaches the technical level corresponding to the work level under a condition where the support information is used.

10. A schedule management device comprising:
reception circuitry to receive operation data from a communication device for acquiring the operation data from an air conditioner to circulate a refrigerant to perform heat exchange between the refrigerant and air and transmitting the acquired operation data;
diagnosis circuitry to diagnose the air conditioner based on the operation data received by the reception circuitry;
selection circuitry to determine a work level indicating a degree of difficulty of repair or maintenance of the air conditioner based on a diagnosis result of the diagnosis circuitry and select a worker who performs work at the work level; and
provision circuitry to provide support information for supporting the repair or maintenance of the air conditioner,
wherein the selection circuitry selects a first worker who reaches a technical level corresponding to the work level and a second worker who is included in workers not reaching the technical level corresponding to the work level and reaches the technical level corresponding to the work level under a condition where the support information is used.

11. A computer readable non-transitory recording medium having a program causing a computer of a schedule management device to execute a process comprising:
receiving operation data from an air conditioner to circulate a refrigerant to perform heat exchange between the refrigerant and air;
diagnosing the air conditioner based on the operation data;
determining a work level indicating a degree of difficulty of repair or maintenance of the air conditioner based on a diagnosis result;
selecting a first worker who reaches a technical level corresponding to the work level and a second worker who is included in workers not reaching the technical level corresponding to the work level and reaches the technical level corresponding to the work level under a condition where support information for supporting the repair or maintenance of the air conditioner is used; and
providing the second worker with the support information.
